(19) United States
(12) Patent Application Publication
(10) Pub. No.: US 2008/0017120 A1
(43) Pub. Date: Jan. 24, 2008

(54) ILLUMINATED DRINKING SYSTEM

(76) Inventor: John M. Hawk, Harrison, TN (US)

Correspondence Address: POWELL GOLDSTEIN LLP, ONE ATLANTIC CENTER, FOURTEENTH FLOOR 1201 WEST PEACHTREE STREET NW, ATLANTA, GA, 30309-3488, US

(21) Appl. No.: 11/458,814

(22) Filed: Jul. 20, 2006

(51) Int. Cl. A01K 7/00

(52) U.S. Cl. 119/72

(57) ABSTRACT

An improved drinking system having a water source capable of delivery ambient water through water lines; watering stations fluidly connected drinking lines; and at least one light source optically connected to at least one of the watering stations. Also provided is a method for selectively distributing water to animals within a farm facility.

### BACKGROUND OF THE INVENTION

1. Technical Field

This invention relates generally to improved drinking and feeding systems for poultry and the like. More particularly, this invention relates to drinking systems for animal farm facilities, which drinking systems incorporate a light source to attract animals to, or allow animals to more easily find the location of, the drinking systems. Further, this invention also relates to the provision of full spectrum light to the animal farm facility to encourage water consumption and to promote more rapid growth of the animals.

2. Prior Art

Commercially raised animals of all types, such as for example poultry, cows and pigs, have been a main food source throughout human history. For example, for hundreds of years, poultry has been raised and processed on small family farms to be sold locally to buyers. However, as the human population increased, the demand for edible poultry has increased, and the per capita consumption of poultry also has increased. As a result of this increased demand for poultry, the production of commercially raised poultry has evolved from small family farm operations to large totally integrated business operations devoted solely to the production of such animals.

In order to help ensure that animals in large farm facilities receive adequate water, commercial farm houses typically have an array of drinking lines. These drinking lines typically have numerous drinker stations, each having a nipple or cup drinker. In order for animals to drink from such a drinking system, the animals have to walk to the drinking lines and displace or engage a drinking valve, cup or trough to allow water to flow. However, in many cases, the animals may not be able to find the watering stations as the typical commercial farm facility can be dark or lit with an improper or disadvantageous color of light. In such an environment, the animals often are unable to find the drinking stations, particularly in darker areas of the farm facilities. As dehydration tends to increase mortality and morbidity rates, it is paramount that the animals in a flock of commercially raised animals have access to and are stimulated properly to ingest the proper amount of water required for proper growth or increased production and receive adequate drinking water.

Accordingly, there is always a need for an improved drinking system for use in poultry and other animal raising facilities. There also is a need for a drinking system having features that draw animals to the drinking system at selected or controlled times. There is a further need for a drinking system comprising a colored light for stimulation of the animals to drink the proper amount of water required for proper growth or increased production. Such a drinking system can help to reduce animal mortality rates and can assist in increasing the quantity and quality of animal meat available from a given flock or herd. It is to these needs, among others, that this invention is directed.

### BRIEF SUMMARY OF THE INVENTION

Briefly, this invention is an improved drinking system for use in an animal raising farm facility. In one illustrative form, the drinking system generally comprises water supply pipes and/or a plurality of drinking stations capable of being illuminated by a light source, including different wavelengths of light. In addition to a light source capable of emitting different wave lengths or patterns, the drinking system can have many of the features of typical drinking systems such as structural supports, water supply pipes and components, drinking valves and catch cups. Further, any component of the watering system can be illuminated, including with the use of luminescent components. Providing the proper amount of water for an animal to grow or to increase the growth rate or final growth size can be desirable as water is the least expensive ingredient in animal production in obtaining a desired weight or weight range.

In a typical drinking system, watering stations are placed along the water supply pipes and are in fluid connection with the water supply pipes. Each water station typically has a watering valve, often referred to as a nipple drinker due to the nipple structure many such watering valves have, that extends downward from and is arranged serially along a water supply pipe. Such drinking systems are well known in the art and have been disclosed and described elsewhere. Many, if not most, of the known drinking systems can be adapted to incorporate the present invention. Likewise, a new drinking system incorporating the present invention also can be constructed using different and alternative materials and components.

In preferred embodiments of the invention, a light source is provided to the drinking system to illuminate the water station and to provide different colors or wavelengths of light throughout the animal confinement facility, the watering valve, the nipple drinker, and/or the catch cup such that at least one of these components is more clearly visible to the animals. In one embodiment of the invention, the light source is adapted to travel through the water supply pipes. In such an embodiment, the interior and possibly even the exterior of the water supply pipe can be reflective or coated with a reflective coating and a portion of the nipple drinker can be translucent or transparent such that the light, which can be a separate light source incorporated in the water supply line and interconnected to or projected through the water supply line, can illuminate the nipple drinker shroud. Alternatively, the water supply pipes can be a translucent or transparent material, such as a plastic or other polymer, such that the water supply pipes also would be illuminated to some extent.

In another embodiment of the invention, optical fibers can extend from a light source and terminate proximal to or within the nipple drinker shroud. The optical fibers can be attached to the water supply pipes or be supported in some other fashion. In yet another embodiment of the invention, optical fibers can be inserted through the water supply pipes and can terminate in the nipple drinker shroud. In another embodiment, the light source includes light emitting diode (LED) placed at or about the drinking stations, or within or on the valve shroud, with electric power lines running to the LEDs. The light emitted from the LEDs can pass through the translucent or transparent valve shroud, if within the valve shroud, or merely light up the area around the drinking station, if on the valve shroud. Another embodiment of the invention includes separate light sources directed at and shining on and illuminating the drinking station, such as small spot lights. This is one of the simplest embodiments of the invention as it does not necessarily include altering the drinking system, but only adding strategically placed lights.

The nipple drinker shroud can be manufactured from a translucent or transparent plastic or other polymer that will allow the light from the light source to cause the shroud to become illuminated. Alternatively, the shroud can have ports or windows allowing the light to exit from the interior of the shroud, or to illuminate the ports or windows, thus allowing the animals to pinpoint the location of the water station. It is possible to activate and deactivate the light source such that the light illuminating from the watering stations can be in light mode or dark mode (on and off), or in different color mode (using different wavelengths of light that may be more attractive to the type of animal in the animal confinement facility). Overall, the drinking system comprises watering stations that are or can be illuminated, which has been found to draw animals towards the drinking system.

Another aspect of this invention is a method for selectively distributing water to animals within a farm facility comprising the steps of (a) providing at least one drinking station capable of being illuminated by a light source, and (b) activating the light source so as to modify the behavior of the animals, including for example increased water consumption and growth, within an farm facility, whereby the activation of the light source causes the drinking station to illuminate thereby allowing the animals to be able to more easily find the drinking station. Such an illustrative method can provide animal caretakers with more control over the drinking habits of their animals.

In operation and use, the drinking system can allow for the selective watering of animals. As individual animals are drawn to the drinking stations by the light emanating therefrom, the actuation of the light source can be used to influence the water drinking patterns of animals. For example, the light source can be turned on or in light mode, in a colored light mode, or in a blink or strobe mode, for a longer period to encourage animals to drink from the drinking stations. Alternatively, the light source can be turned off or in a dark mode to discourage the animal from drinking water. Thus, it is possible to influence the water drinking patterns of animals so to optimize the efficiency of the farm facility relative to the raising and growth of the animals. Further, the invention can be used to provide different colors of light during different stages of growth.

It is also possible to include a timer to regulate when the light source emanates light. In this arrangement, the drinking system may be set to illuminate at specific times or for specific lengths of time so as to draw the animals to the watering stations at specific times or for specific lengths of time. Alternatively, the drinking system can have a switch that allows the light source to be operated by the flow of water. In this arrangement, the switch can be a valve flap that allows the light to be turned on and off in accordance with the water flow. Further, the drinking system can have a common on-off switching means, photocell switching means, or any other known or future developed switching means to turn the illumination on and off.

The light source of the present invention may be any suitable light source that produces visible (to the animals) electromagnetic radiation. For example, such light sources can include light output transducers such as low voltage incandescent lamps, halogen and/or LEDs, series-connected or in parallel in the respective circuit. In some cases, it may be suitable to select or include an ultraviolet light as this type of light may be able to disinfect the water within the water supply pipes.

It is contemplated that the drinking system can have more than one light source within the ends of a drinking line. For example, the drinking system can have bolstering light sources and/or light amplifiers within the drinking line, as well as different wavelength (color) light sources. Such an arrangement can help ensure proper illumination for each of the drinking stations. Further, such an arrangement may allow for the more selective illumination of the drinking stations in that such an arrangement can allow more control over which particular watering stations are lit up.

It is also contemplated that the animals can use the drinking system in a manner similar to any other drinking station. For example, once at the watering valves, the animals peck or nudge against the exposed end of an actuator stem in a known type of watering valve causing the stem to be angularly displaced in a rocking relation from its closed relation relative to the pin so that the pin is caused to be displaced upwardly, releasing water. The extent of side displacement will be generally correlated to the level of force imposed such that the smaller chicks will effect lesser displacement than will the larger more mature birds.

These features and other features and advantages of the present invention will become more apparent to those of ordinary skill in the relevant art when the following detailed description of the preferred embodiments is read in conjunction with the appended drawings in which like reference numerals designate like components throughout the several views.

### BRIEF DESCRIPTION OF THE FIGURES

FIG. 1 is a schematic view of a drinking system according to this invention illustrating several alternative embodiments in a single system.

FIG. 2 is a schematic view drawing of one embodiment of this invention.

FIG. 3A is a schematic side view of a first embodiment of this invention showing an internal reflective light path.

FIG. 3B is a schematic side view of a second embodiment of this invention showing an embedded diode light path.

FIG. 3C is a schematic side view of a third embodiment of this invention showing an external light bulb light path.

FIG. 3D is a schematic side view of a fourth embodiment of this invention showing an external spot light path.

FIG. 4 is an exemplary watering valve suitable with the embodiment shown in FIG. 1

FIG. 5 is top schematic view of the drinking system shown in FIG. 1 as installed in an exemplary animal raising facility.

### DETAILED DECRIPTION OF PREFERRED EMBODIMENTS

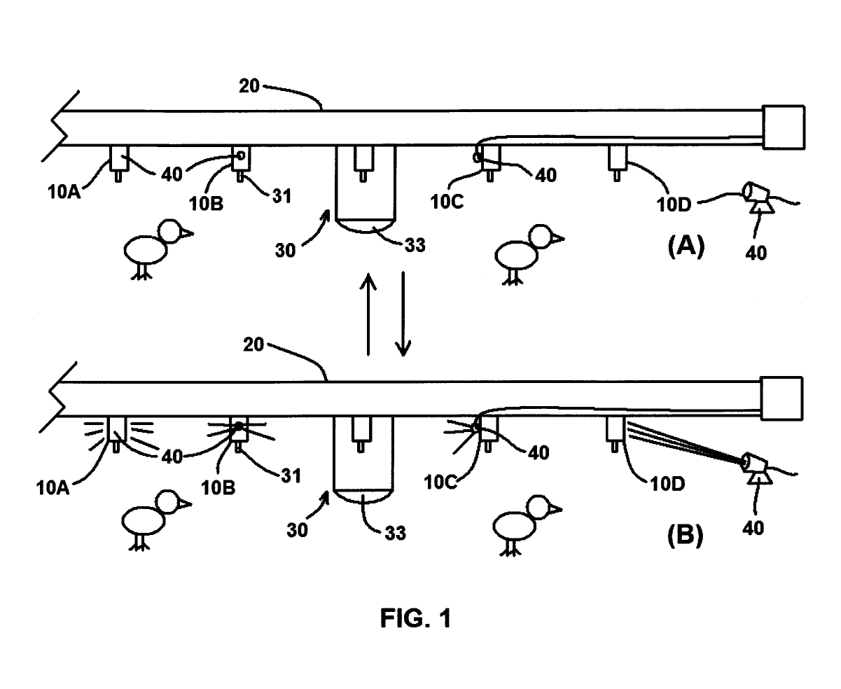

Illustrative embodiments of system and method according to the present invention are shown in FIGS. 1 through 5. Although drinking system 10 is shown in the figures in connection with a chicken coop as the illustrative farm facility A, it is understood that the drinking system 10 may be used in connection with any farm facility A and with any type of commercially raised animal. The various types of animals that can be raised in such facilities including as non-limiting examples chickens, geese, ducks, turkeys, other poultry, hogs, cattle, other livestock, rabbits, guinea pigs, and the like. Further, drinking system 10 is suitable for use with floor drinking systems, cage drinking systems, and other drinking systems. While the invention is described herein in conjunction with the preferred embodiments, it will be understood that the invention is not limited to these embodiments.

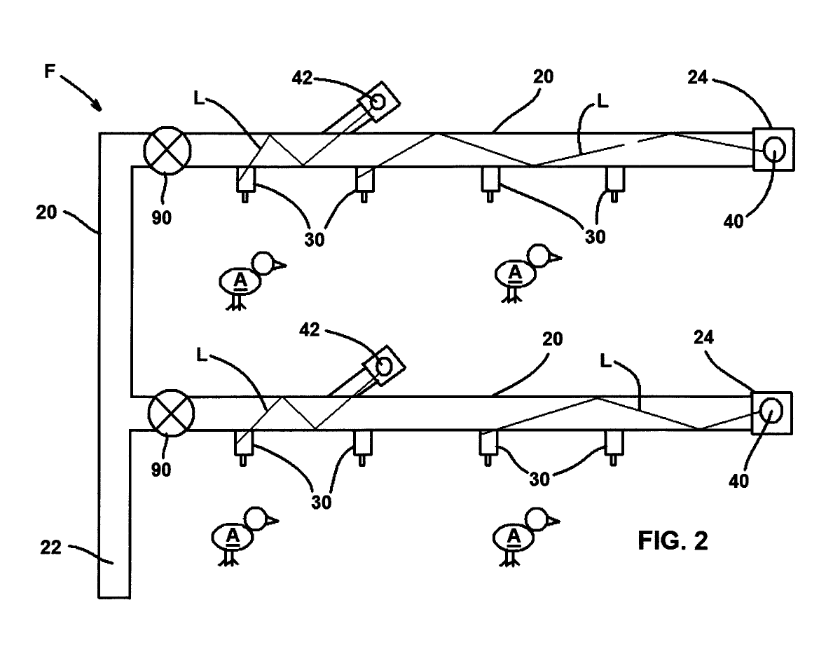

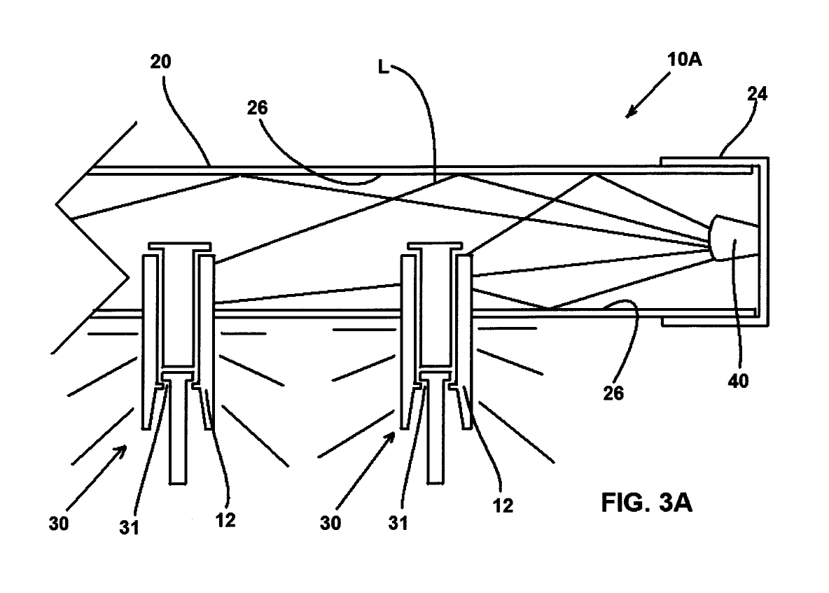

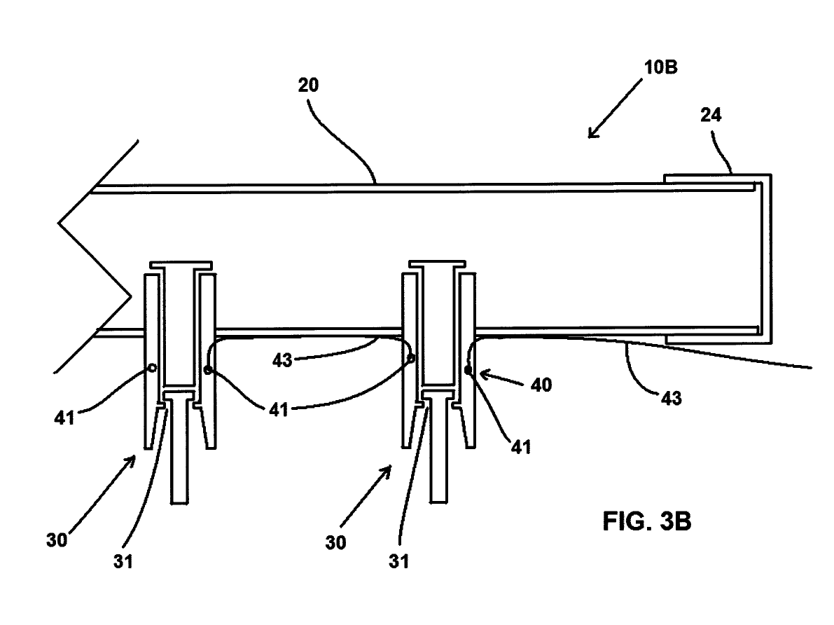

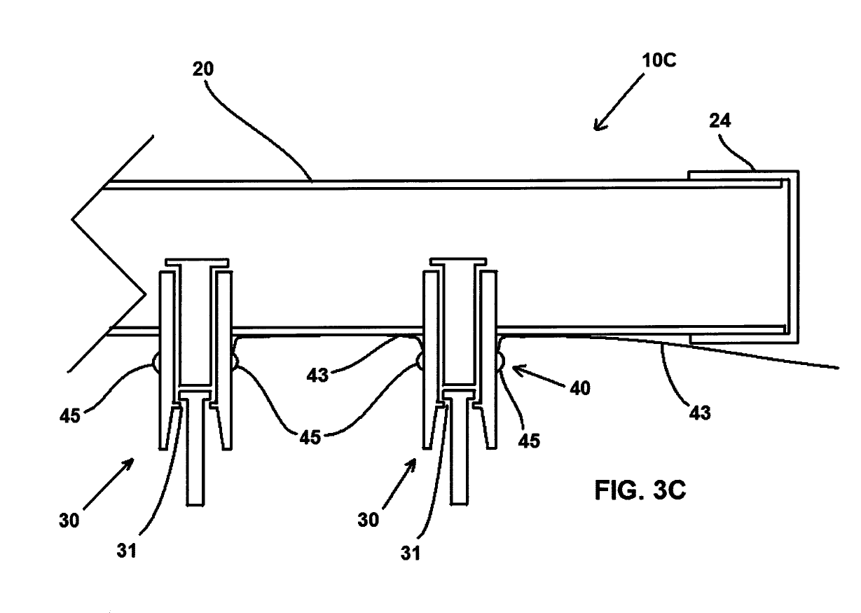

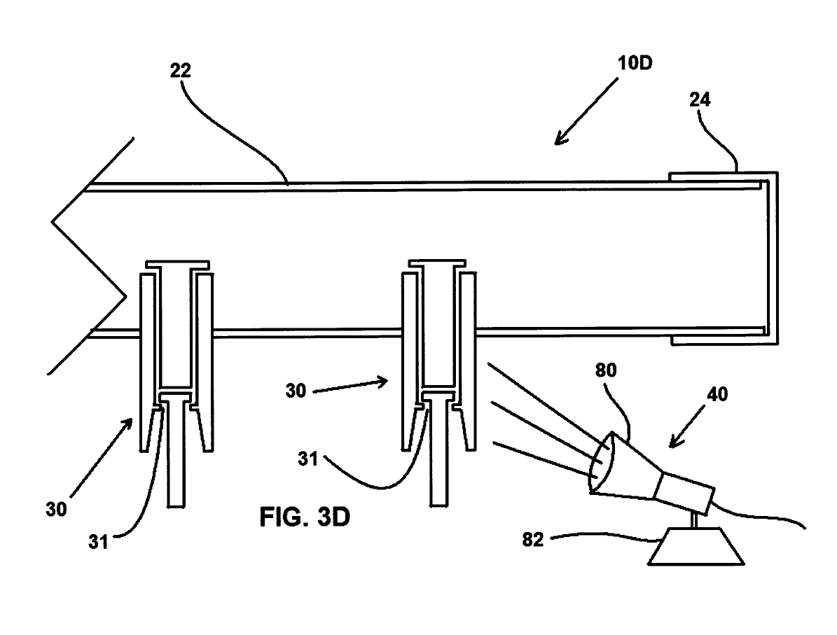

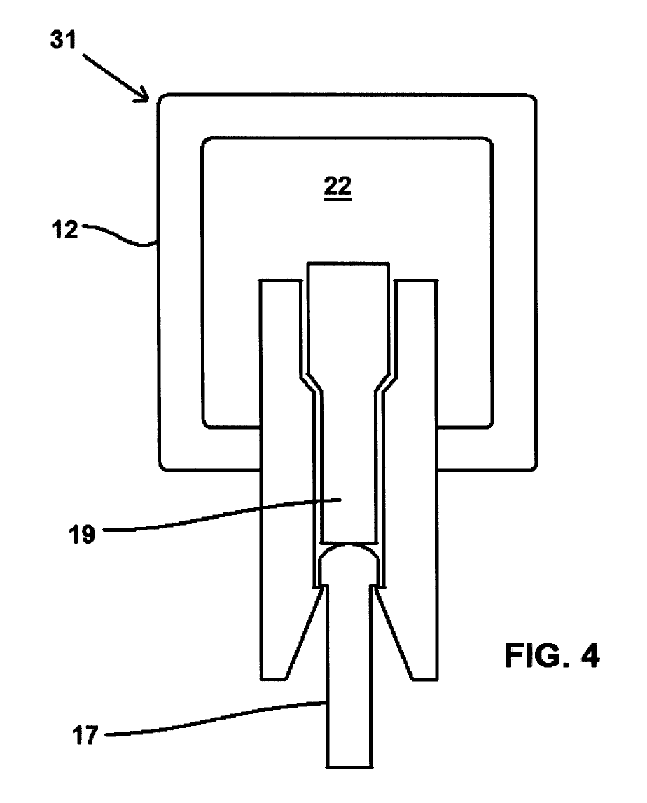

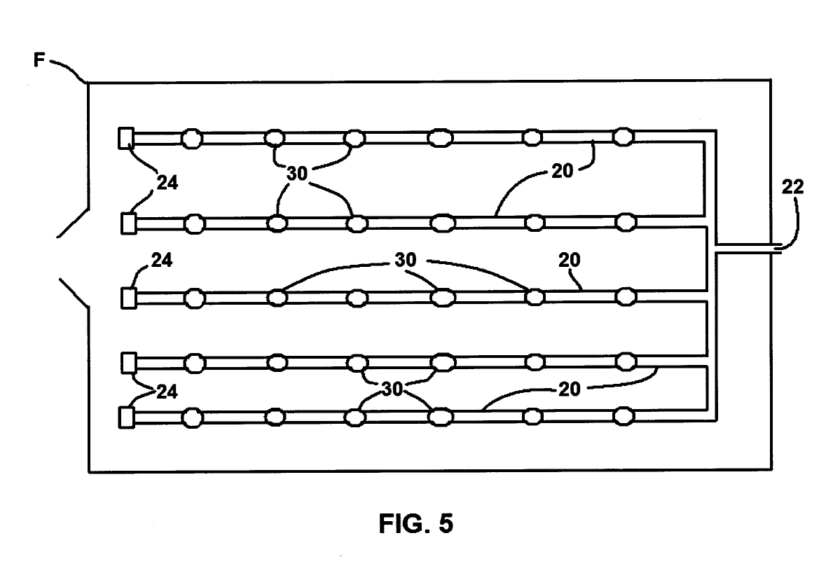

Referring now to the figures in general, the figures illustrate preferred embodiments of the invention in the best mode known to the inventor at this time. Specifically, FIG. 1 is a perspective view of a drinking system according to this invention showing the drinking system alternating between light and dark modes or between different light color modes. FIG. 2 is a schematic drawing of one embodiment of the drinking system showing the watering stations optically connected to the light sources. FIG. 3A is a schematic drawing of a first exemplary embodiment of the invention showing the light path through one of the water supply pipes from the associated light source, termed an internal pipe light source. FIG. 3B is a schematic drawing of a second exemplary embodiment of this invention showing the light source proximal to the drinking stations and represents the use of electric lines to illuminate an LED or the like embedded within a translucent nipple shroud. FIG. 3C is a schematic drawing of a third exemplary embodiment of this invention showing the light source proximal to the drinking stations and represents the use of electric lines to illuminate a bulb or the like attached to the external surface of a nipple shroud. FIG. 3D is a schematic drawing of a fourth exemplary embodiment of this invention showing the light source distal from to the drinking stations and represents the use of spot lights to shine no the nipple shroud. FIG. 4 is an exemplary watering valve, which can be an ordinary watering valve, suitable with the drinking system shown in FIG. 1. FIG. 5 is a schematic view of the drinking system shown in FIG. 1 in use in an exemplary farm facility. Further, it is contemplated that the invention can be scaled up or down both in size and in color light and/or intensity to handle larger or smaller animals, or different types of animals.

FIG. 1 illustrates a schematic side view of a generalized animal drinking system 10 for use in a farm facility A. In its most basic form, drinking system 10 generally comprises water supply pipes 20 and a plurality of drinking stations 30 each capable of being illuminated by a light source 40. In addition to light source 40, drinking system 10 can have many of the typical features such as a structural support, drinking valves 31 and catch cups 33. Watering stations 30 are placed along water supply pipes 20 and are in fluid connection with water supply pipes 20. Watering valves 31 extend downward and are arranged serially along a water supply pipe 20. In a typical embodiment, it is possible to activate and deactivate the light source 40 such that the light illumination status of watering stations 30 can be in light mode (A) or dark mode (B). Overall, the drinking system 10 is able to produce watering stations 30 that illuminate, which has been found to draw animals towards drinking system 10.

FIG. 1 also shows four embodiments of the invention for illustrative purposes. A first embodiment 10A, and as disclosed in more detail in conjunction with FIG. 3A, comprises an internal reflective light path. A second embodiment 10B, and as disclosed in more detail in conjunction with FIG. 3B, comprises an embedded diode light path. A third embodiment 10C, and as disclosed in more detail in conjunction with FIG. 3C, comprises an external light bulb light path. A fourth embodiment 10D, and as disclosed in more detail in conjunction with FIG. 3D, comprises an external spot light path.

FIG. 2 illustrates a schematic view of one embodiment of drinking system 10 in a typical farm facility F. In this embodiment, drinking system 10 includes water supply pipes 20, a plurality of watering stations 30 connected to water supply pipes 20, and at least one light source 40 in optical connection with watering station 30. In this embodiment, light source 40 is positioned at the terminal end 24 of each water supply pipe 20 and is able deliver light to watering stations 30 from that position and through water supply pipes 20. The light L from light source 40 travels along water supply pipes 20 and eventually is visible through the translucent valve shroud 12 of drinking valve 31. Additional or bolstering light sources 42 can be positioned along water supply pipes 20 to ensure an adequate amount of light is provided to illuminate the watering stations 30

FIG. 3A illustrates a first illustrative embodiment of drinking system 10A embodiment having light source 40 connected optically to watering station 30 such that the light L is propagated through water supply pipe 20 and dispersed at watering station 30. In this embodiment, water supply pipes 20 are able to carry or relay the light L from light source 40 to the plurality of watering stations 30. Water supply pipes 20 are preferably internally reflective so to allow light L to travel along and deflect to each of watering stations 30. For example, the light L guided through water supply pipes 20 is deflected by the reflective interior walls 26 of water supply pipes 20 and at least partially exits through the plurality of watering stations 30, namely eventually is visible through the translucent or transparent valve shroud 12 of drinking valve 31. It is not necessary that the light L illuminating the valve shroud 12 be overly bright; it generally is necessary that the light L cause the valve shroud 12 to be illuminated to a degree that it will be apparent and attractive to the animals A in the facility F. Drinking valve 31 as shown throughout the FIGs. is merely a representative schematic view of such a valve and is not intended to be structurally limiting.

In one embodiment, the light L in water supply pipes 20 can be introduced via optics or deflection optics at one end of water supply pipes 20, preferably the terminal end 24. In this embodiment, the light L is introduced in at approximately the center of terminal end 24 of water supply pipes 20. As shown, the light L is emitted from the light source 40 in the general direction of watering stations 30 and is reflected by the internal surface wall 26, which preferably has a reflective coating, into water valves 31 of watering stations 30. The light L is visible within the farm facility F through the material of the water valve 31. Preferably, the light L is emitted from the light source 40 in a dispersed beam, so that the light L travels along water supply pipes 20, is reflected internally within water supply pipes 20 and is deflected randomly to each watering station 30. Once the light L arrives at watering stations 30, the light L passes through the valve shroud 12 of watering valve 31 of watering station 30 and is visible from outside the drinking system 10 by the animals.

Although a bright white light is preferable, as this will travel through the water and the water supply pipes 20 best, the light L can be any color desired. For example, if a certain animal sees one color better than another color, either the valve shroud 12 can be that color, or the valve shroud can be white or clear and the light L can be that color. Additionally, an ultraviolet light also can be shone through the water and the water supply pipes 20. An ultraviolet light can be useful as it can act as a disinfecting agent to the water in the water supply pipes 20, thus helping to increase the health of the animals drinking the water. Further, if the valve shroud 12 is white or contains white, an ultraviolet light can cause the valve shroud 12 to glow and be visible to the animals. One preferable color of light is a full spectrum light imitating sunlight. As shown in FIG. 2, there can be several light sources 40 or bolstering light sources 42 located along the water supply pipes 20 so as to ensure an adequate amount of light L. Light sources can be any known or future developed type of light, such as incandescent bulbs, fluorescent bulbs, noble gas bulbs, diodes, lasers, etcetera.

FIG. 3B illustrates a second illustrative embodiment of drinking system 10B for use in a farm facility F. Again, drinking system 10 is a commonly available drinking system and can include water supply 22 connected to water supply pipes 20, a plurality of watering stations 30 connected to water supply pipes 20, at least one light source 40 in optical connection with watering station 30. In the example shown in FIG. 3B, light source 40 includes light emitting diode (LED) 41 placed at or about watering station 30. More specifically, LED 41 is embedded within valve shroud 12 and the emitted light L can pass through valve shroud 12 of watering valve 31. LEDs 41 are connected to any common electricity supply via wires 43. The embodiment shown in FIG. 3B is slightly less invasive than the embodiment shown in FIG. 3A as it does not involve the use of light being shone through the water supply pipes 20, but uses preferably external wires 43 to energize LEDs 41. Wires 43 can be attached to the outside of water supply pipes 20.

FIG. 3C illustrates a third illustrative embodiment of drinking system 10C for use in a farm facility F. Again, drinking system 10 is a commonly available drinking system and can include water supply 22 connected to water supply pipes 20, a plurality of watering stations 30 connected to water supply pipes 20, at least one light source 40 in optical connection with watering station 30. In the example shown in FIG. 3C, light source 40 includes a light bulb 45 placed at or about watering station 30. More specifically, light bulb 45 is attached to the outer surface of valve shroud 12 and the emitted light L merely shines from the surface of valve shroud 12 of watering valve 31. Light bulbs 45 are connected to any common electricity supply via wires 43. The embodiment shown in FIG. 3C is slightly less invasive than the embodiment shown in FIG. 3B as it does not involve the use of light sources embedded in valve shroud 12 (nor does it involve light being shone through the water supply pipes 20), but uses preferably external wires 43 to energize light bulbs 45. Optionally, Light bulbs 45 can be replaced with LEDs 41. Wires 43 can be attached to the outside of water supply pipes 20. Also alternatively, light source 40 can be an optical cable or fiber connected to watering valve 30 and having a terminating end proximal to water valve 31.

FIG. 3D illustrates a fourth illustrative embodiment of drinking system 10D for use in a farm facility F. In this embodiment a typical drinking system 10 is supplemented with separate spot lights 80 that shine on or illuminate watering stations 30. In this embodiment, spot lights 80 can be mounted on the farm facility F wall, on poles, or on any other type of support 82 such that spot lights 80 can be directed towards watering stations 30. Pinpoint spot lights are preferable as such spot lights can direct a light beam at watering stations 30 without illuminating the rest of the farm facility F. Thus, this embodiment is a retrofit structure and method for illuminating watering stations 30 already installed in a farm facility F.

FIG. 4 schematically illustrates a representative watering valve 31. Watering valve 31 can be any of the commercially available watering valve structures. In certain preferred embodiments, it is preferred that watering valve 31 comprises a shroud that can be made of a translucent or transparent material. In a preferred embodiment, at least a portion of watering valve 31, and preferably the valve shroud 12, is translucent, such that the light L can be transmitted there through and be visible to the animals from the outside of drinking system 10. Thus, in this structure, the light L traveling through water supply pipes 20 enters watering valve 31 as watering valve 31 is in fluid communication with water supply pipe 20. Light L then can be seen by the animals through the translucent valve shroud 12 of watering valve 31.

Another embodiment of this invention includes a method for selectively distributing water to animals within a farm facility comprising the steps of:

a) providing at least one drinking station capable of being illuminated by a light source;

b) activating the light source so the modify the behavior of the animals within an animal farm facility,

whereby the activation of the light source causes the drinking station to illuminate. The method can provide animal caretakers with more control over the drinking habits of their animals.

Referring now to FIG. 1 and FIG. 5, drinking system 10 in operation and use can allow for the selective watering of animals A. As individual animals A are drawn to drinking stations 30 by the light emanating therefrom, the actuation of the light source 40 can be used to influence the water drinking patterns of animals A. For example, light source 40 can be in light mode for a longer period to encourage animals to drink from drinking stations 30. Alternatively, the light source 40 can be turned off or in a dark mode or to another color of light to discourage the animal A from drinking water and animals A will generally migrate away from watering stations 30. Thus, it is possible to influence the water drinking patterns of animals A so to optimize the efficient of the farm facility F.

It is also possible to include a timer (not shown) to regulate when the light source 40 emanates light. In this arrangement, the drinking system 10 may be set to engage and to provide water at specific times or to draw animals A to the watering stations 30 at specific times. For example, the timer can turn on both the water and the light source 40, or just the light source 40 assuming the water flow is always on, at set times and/or for set time periods. Timers suitable with this invention 10 includes know programmable timers. The timer can be operatively connected to shutoff valves 90 typically associated with common drinking systems.

Alternatively, drinking system 10 can have a switch that allows the light source 40 to be operated by the flow of water. In this arrangement, the switch can be a valve that allows the light source 40 to be turned on and off in accordance with the water flow. For example, the valve can be connected to a switch so that the flow of water displaces the valve, which thereby triggers the light sources 40. The switch can be operatively connected to shutoff valves 90 typically associated with common drinking systems.

As can been seen, light source 40 of the present invention may be any suitable light source 40 that produces electromagnetic radiation. For example, such light sources 40 can include light output transducers such as low voltage incandescent lamps and light-emitting diodes (LEDs), series-connected or in parallel in the respective circuit. In some cases, it may be suitable to select an ultraviolet light as this type of light may be able to disinfect the water within the water supply pipes 20. Other suitable light sources include fluorescent, noble gas and laser light sources.

It is contemplated that drinking system 10 can have more than one light source 40 within the ends of water supply pipe 20. For example, as shown in FIG. 2, drinking system 10 can have bolstering light sources 42 along water supply pipes 22. Such an arrangement can help ensure proper illumination for each of the watering stations 30. For another example, as shown in FIGS. 3A-3D, each terminating end 24 of water supply pipes 20 can have a light source 40. Further, such an arrangement may allow for the more selective illumination of the watering stations 30 in that such an arrangement can allow more control of particular watering stations 30 to be illuminated. The positioning and combination of light sources 40 can be determined by those of ordinary skill in the art without undue experimentation based on the quantity and brightness of light desired.

Preferably, light source 40 or the light contained therein is covered by a barrier so to prevent water from directly contacting the light source 40. The light source 40 or opening preferably is additionally sealed in a water tight fashion by means of a transparent or scatter type covering. An openable lid (not shown) can be provided on the light source 40 to provide a means for cleaning and maintaining the light source 40.

Light source 40 can be a simple light with a conventional power cord having a plug connection to a standard AC electrical power source (not shown). For example, if the light sources 40 are wired to each watering station 30, it can be necessary to wire each of the light sources 40 to a power source, which can be a single source or can be multiple sources. A control unit can be configured with an integrally mounted power plug. One of ordinary skill in the art can select a power source for drinking system 10 without undue experimentation.

It is contemplated that drinking system 10 may be used with a typical animal raising facility F. For example, an exemplary animal raising facility F can have multiple drinking lines, each hundreds of feet long and each having hundreds of watering stations 30 installed thereon.

It is also contemplated that the animals A can use the drinking system 10 in manner similar to any other drinking system. For example, once at the watering stations 30, the animals A peck or nudge against the exposed end of actuator stem 17 (see FIG. 4 for an illustrative structure for watering valve 31) causing the actuator stem 17 to be angularly displaced in a rocking relation from its closed relation relative to pin 19 that is caused to be displaced upwardly. The extent of displacement will be generally correlated to the level of force imposed such that the smaller chicks will effect lesser displacement than will the larger more mature birds, resulting in less water being supplied to smaller birds. This is known in the art.

It is also contemplated that the watering stations 30 can be modular. Watering stations 20 can fitted in an exchangeable manner and can be replaced individually with another specimen, with different features or otherwise, without it being necessary to shut off the water supply line 22, and thus put the system 10 out of operation. Suitable watering stations 30 for use with this invention are known and disclosed in the prior art. For example, one such watering station 30 includes the drinking valve disclosed in U.S. Pat. No. 6,308,657. The structure of watering nipples has been disclosed, for example, in the following U.S. Pat. Nos. 2,457,159, 2,486,729, 3,322,101, 3,418,977, 4,416,221, 4,984,537, 5,193,485, and 6,058,881. In some instances, it may be necessary to modify the material of the relevant parts so that light can pass therethrough. One of ordinary skill in the art may select a suitable watering station 30 without undue experimentation.

The dimensions of drinking system 10 can depend on size of animal raising facility F in which drinking system 10 is being employed. For example, in a large animal raising facility F, it may be appropriate to have a larger drinking system 10 and in a smaller farm facility F, it may be appropriate to have a smaller drinking system 10. As part of drinking system 10 can be designed to be outside farm facility F, drinking system 10 in some embodiments may be larger (longer) than animal raising facility F. One of ordinary skill in the art can selected the dimensions of drinking system 10 for a specific farm facility F without undue experimentation.

The numbers of drinking systems 10 or watering stations 30 as shown and described herein are for illustrative purposes. The actual number of drinking systems 10 or watering stations 30 used with the present invention can be substantially varied and will depend on numerous factors including the size of the farm facility F, the dimensions of drinking system 10 or watering stations 30 and the desired spacing between such items, and animals A. One of ordinary skill in the art can select the number of drinking systems 10 or watering stations 30 to be used with drinking systems 10 without undue experimentation.

The above detailed description of the preferred embodiments, examples, and the appended figures are for illustrative purposes only and are not intended to limit the scope and spirit of the invention, and its equivalents, as defined by the appended claims. One skilled in the art will recognize that many variations can be made to the invention disclosed in this specification without departing from the scope and spirit of the invention.

What is claimed is:

1. An improved drinking system comprising:
a) a water source capable of delivering water through water lines;
b) watering stations fluidly connected drinking lines; and
c) at least one light source optically connected to at least one of the watering stations.

2. The system as claimed in claim 1, wherein the light source is positioned within a drinking valve of one of the watering stations.

3. The system as claimed in claim 1, wherein the light source is an optical cable wired through at least one of the watering stations.

4. The system as claimed in claim 1, wherein the light source is connected to an adjunct end of the water drinking lines.

5. The system as claimed in claim 1, further comprising a means for selectively activating and deactivating the light source.

6. The system as claimed in claim 1, wherein the light source is selected from the group consisting of ultraviolet light sources, white visible light sources, colored visible light sources, and combinations thereof.

7. The system as claimed in claim 1, wherein the watering stations comprise a water valve capable of delivery water.

8. The system as claimed in claim 1, where at least part of the watering stations is transparent or translucent.

9. The system as claimed in claim 1, further comprising a timer.

10. The system as claimed in claim 1, further comprising a switch.

11. The system as claimed in claim 1, further comprising a means for dispersing the light from the light source.

12. The system as claimed in claim 1, wherein the at least one light source is within a watering valve of at least one of the plurality of watering stations.

13. An improved drinking system for delivering water comprising:
a) a water source capable of delivery ambient water through water lines;
b) watering stations fluidly connected drinking lines; and
c) at least one light source optically connected to at least one of the watering stations,
wherein at least of portion of the watering stations is transparent or translucent.

14. The system as claimed in claim 13, wherein the light source is positioned within a drinking valve of one of the watering stations.

15. The system as claimed in claim 13, wherein the light source is an optical cable wired through at least one of the watering stations.

16. The system as claimed in claim 13, wherein the light source is connected to an adjunct end of the water drinking lines.

17. The system as claimed in claim 13, wherein the light source is selected from the group consisting of: uv light sources, white light sources, x-ray sources, and combinations thereof.

18. The system as claimed in claim 13, wherein the light source is light emitting diode.

19. The system as claimed in claim 13, wherein the at least one light source is within a watering valve of at least one the watering stations.

20. A method for illuminating a plurality of drinking stations for animals comprising the steps:
a) providing drinking stations capable of being illuminated by a light source;
b) activating the light source so the modify the behavior of the animals within an farm facility,
whereby the activation of the light source illuminates at least one of the drinking station.

21. The method as claimed in claim 20, whereby the activation of the light source encourages the animals aggregate around the at least one illuminated drinking station.

22. The method as claimed in claim 20, wherein light source is activated by a timer.

23. The method as claimed in claim 20, wherein the light source is activated by the flow of water through a drinking pipe connected to the at least one drinking station.
